(19) United States
(12) Patent Application Publication
(10) Pub. No.: US 2012/0216288 A1
(43) Pub. Date: Aug. 23, 2012

(54) METHOD AND SYSTEMS FOR SECURE DISTRIBUTION OF CONTENT OVER AN INSECURE MEDIUM

(75) Inventors: Victor I. Sheymov, Vienna, VA (US); Jan Willem Valentijn Kerseboom, Amsterdam (NL); James W. Dyer, Port St. Lucie, FL (US); Jean Dyer, Port St. Lucie, FL (US)

(73) Assignee: INVICTA NETWORKS, INC., Reston, VA (US)

(21) Appl. No.: 13/320,411

(22) PCT Filed: May 14, 2010
(86) PCT No.: PCT/US10/35016

§ 371 Date: Mar. 13, 2012

Related U.S. Application Data
(60) Provisional application No. 61/213,191, filed on May 15, 2009.

(51) Int. Cl. G06F 21/00

(52) U.S. Cl. 726/26

(57) ABSTRACT

A method, system, and computer program product for secure distribution of content over an insecure medium, including a recipient device configured to receive content; and a sender device configured to request from the recipient device a unique identification associated with the recipient device, before sending to the recipient device, the content and a unique key associated with the content for use of the content by the recipient device. The sender device is configured to request the unique identification associated with the recipient device from the recipient device during a predetermined time interval after sending the key, and after verification of the unique identification, send a new key associated with the content to the recipient device for further use of the content by the recipient device.

### CROSS REFERENCE TO RELATED APPLICATIONS

The present invention claims benefit of priority to U.S. Provisional Patent Application Ser. No. 61/213,191 of SHEYMOV et al., entitled “METHOD AND SYSTEMS FOR SECURE DISTRIBUTION OF CONTENT OVER AN INSECURE MEDIUM,” filed on May 15, 2009, the entire disclosure of which is hereby incorporated by reference herein.

### BACKGROUND OF THE INVENTION

1. Field of the Invention

This invention relates to systems and methods for secure content distribution. In particular, this invention relates to systems and methods for secure distribution of content over an insecure medium.

2. Discussion of the Background

Delivery of content over insecure medium, such as Internet, and the like, is more and more common. Various types of content, such as movies, music, computer games, computer applications, etc., are probably more often delivered over the Internet than is any other form, such as via stores, mail, etc. However, security of such content delivery is not considered adequate in many instances. This leads to frequent cases of information theft, piracy, etc. Economic losses of these occurrences are significant.

### SUMMARY OF THE INVENTION

The above and other problems are addressed by exemplary embodiments of the present invention, advantageously, which makes delivery of content, such as movies, music, computer games, computer applications, and the like, more secure.

Accordingly, aspects of the present invention relate to a method, system, and computer program product for secure distribution of content over an insecure medium, including a recipient device configured to receive content; and a sender device configured to request from the recipient device a unique identification associated with the recipient device, before sending to the recipient device, the content and a unique key associated with the content for use of the content by the recipient device. The sender device is configured to request the unique identification associated with the recipient device from the recipient device during a predetermined time interval after sending the key, and after verification of the unique identification, send a new key associated with the content to the recipient device for further use of the content by the recipient device.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is a functional block diagram for illustrating exemplary systems and methods for secure distribution of content over an insecure medium, according to this invention.

### DETAILED DESCRIPTION OF THE INVENTION

The present invention includes recognition that a weakness of existing content delivery systems and methods is that their security is usually based on a cryptographic algorithm with a key provided to unlock the content and make it usable. This creates a situation with more than one venue to attack the system. For instance, once the cryptographic key obtained by an unauthorized party either through theft, deceit, or crypto analysis, the content could be unlocked. That would allow unauthorized use of the content such as copying and sales.

The exemplary systems and methods of this invention are based on two principles: identification of the recipient device, and issuance of a temporary use license with periodic renewal. Once the transaction is initiated, the identity of the recipient device, such as IP address, MAC address, motherboard serial number, processor serial number, and the like, is registered by the sender, such as a content merchant's server, and the like. During the transaction, the recipient device is issued a temporary use license and cryptographic keys for unlocking the content, such as movies, music, computer games, computer applications, and the like, and a system component for making the content usable and for future secure communications with the sender. After a certain period of time, the content must renew its license via the system component to allow its continuing use. If such a renewal is not done, the content is disabled, destroyed, or otherwise made unusable by the system component.

During the license renewal, the system component attached to or imbedded in the license or content, contacts the sender using the earlier received key and verifies the identity, previously registered with the sender. If the key and the identity are valid, the sender issues another temporary use license and supplies the recipient device with a new key for the next renewal. This process is repeated until the intended total license period ends. At the end of the total license period, the user is either is required to further renew the total license or can granted free further use of the content, or the content is disabled, and the like.

This approach provides security control of content distribution. Even in a case of inadvertent breach of security, unauthorized use of the content is limited to less than a period between the two renewals.

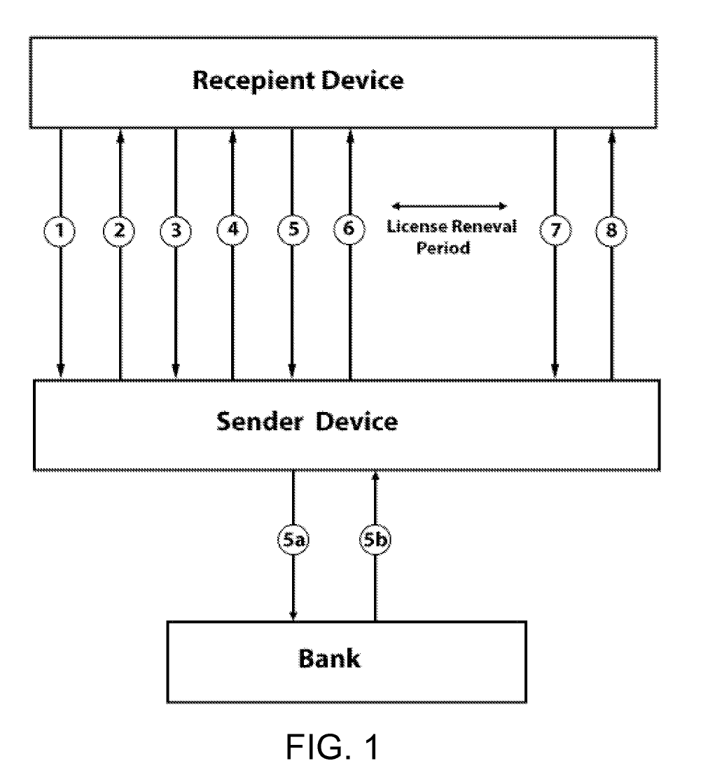

FIG. 1 is a functional block diagram for illustrating exemplary systems and methods described above for secure distribution of content over an insecure medium, according to this invention. In FIG. 1, at step 1, initial contact is made by the content recipient device with one or more content sender devices. At step 2, an acknowledgement is sent by the sender device and a recipient device ID is requested by the sender device. At step 3, the ID is sent by the recipient device to the sender device. At step 4, financial (e.g., credit card, etc.) data from the recipient device is requested by the sender device. At step 5, the financial data is sent by the recipient device to the sender device. At step 5a, the sender device makes a bank card service request to a bank, based on the financial data, and at step 5b, receives an acknowledgement from the bank.

At step 6, the acknowledgement, content, key, license, and a renewal system component is sent by the sender device to the recipient device. At step 7, the ID is again requested from the recipient device by the sender device for license renewal. At step 8, the new license renewal, and new key is sent by the sender device to the recipient device. As shown in FIG. 1, steps 7-8 are repeated during the entire license renewal period, for example, at predetermined time intervals (e.g., hourly, daily, weekly, monthly, etc.)

The devices and subsystems of the exemplary embodiments can be implemented either on a single programmed general purpose computer or a separate programmed general purpose computer. However, the exemplary system can also be implemented on a special purpose computer, a programmed microprocessor or microcontroller and peripheral integrated circuit element, an ASIC or other integrated circuit, a digital signal processor, a hardwired electronic or logic circuit such as a discrete element circuit, a programmable logic device such as PLD, PLA, FPGA, PAL, or the like. In general, any device capable of implementing a finite state machine that is in turn capable of implementing the methods of the exemplary embodiments can be used to implement the exemplary system according to this invention.

Furthermore, the disclosed methods may be readily implemented in software using object or object-oriented software development environments that provide portable source code that can be used on a variety of computer or workstation hardware platforms. Alternatively, the exemplary system can be implemented partially or fully in hardware using standard logic circuits or VLSI design. Whether software or hardware is used to implement the systems in accordance with this invention is dependent on the speed and/or efficiency requirements of the system, the particular function, and the particular software and/or hardware systems or microprocessor or microcomputer systems being utilized. However, the exemplary system and method illustrated herein can be readily implemented in hardware and/or software using any known or later-developed systems or structures, devices and/or software by those of ordinary skill in the applicable art from the functional description provided herein and with a general basic knowledge of the computer arts.

Moreover, the disclosed methods may be readily implemented as software executed on a programmed general purpose computer, a special purpose computer, a microprocessor, or the like. In these instances, the methods and systems of this invention can be implemented as a program embedded on a personal computer, such as a JAVA.RTM. or CGI script, as a resource residing on a server or workstation, a routine embedded on a dedicated system, a web browser, a PDA, a dedicated system, or the like. The exemplary system can also be implemented by physically incorporating the system into a software and/or hardware system, such as the hardware and software systems of a computer workstation or a dedicated system.

Thus, the devices and subsystems of the exemplary embodiments can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, etc. Non-volatile media can include, for example, optical or magnetic disks, magneto-optical disks, and the like. Volatile media can include dynamic memories, and the like. Transmission media can include coaxial cables, copper wire, fiber optics, and the like. Common forms of computer-readable media can include, for example, a floppy disk, a flexible disk, hard disk, magnetic tape, any other suitable magnetic medium, a CD-ROM, CDRW, DVD, any other suitable optical medium, a RAM, a PROM, an EPROM, a FLASH-EPROM, any other suitable memory chip or cartridge, or any other suitable medium from which a computer can read.

It is, therefore, apparent there has been provided in accordance with the present invention, systems and methods for secure distribution of content over an insecure medium. While this invention has been described in conjunction with a number of embodiments, it is evident that many alternatives, modifications, and variations would be or are apparent those of ordinary skill in the applicable art. Accordingly, the invention is intended to embrace all such alternatives, modifications, equivalents and variations that are within the spirit and scope of this invention.

What is claimed is:

1. A system for secure distribution of content over an insecure medium, the system comprising:
a recipient device configured to receive content; and
a sender device configured to request from the recipient device a unique identification associated with the recipient device, before sending to the recipient device, the content and a unique key associated with the content for use of the content by the recipient device,
wherein the sender device is configured to request the unique identification associated with the recipient device from the recipient device during a predetermined time interval after sending the key, and after verification of the unique identification, send a new key associated with the content to the recipient device for further use of the content by the recipient device.

2. A method for secure distribution of content over an insecure medium, the method comprising:
receiving content by a recipient device;
requesting from the recipient device by a sender device a unique identification associated with the recipient device, before sending by the sender device to the recipient device, the content and a unique key associated with the content for use of the content by the recipient device;
requesting by the sender device the unique identification associated with the recipient device from the recipient device during a predetermined time interval after sending the key; and
after verification of the unique identification, sending by the sender device a new key associated with the content to the recipient device for further use of the content by the recipient device.

3. A computer program product for secure distribution of content over an insecure medium, and including one or more computer readable instructions embedded on a computer readable medium and configured to cause one or more computer processors to perform the steps of:
receiving content by a recipient device;
requesting from the recipient device by a sender device a unique identification associated with the recipient device, before sending by the sender device to the recipient device, the content and a unique key associated with the content for use of the content by the recipient device;
requesting by the sender device the unique identification associated with the recipient device from the recipient device during a predetermined time interval after sending the key; and
after verification of the unique identification, sending by the sender device a new key associated with the content to the recipient device for further use of the content by the recipient device.
